(19) United States
(12) Patent Application Publication
(10) Pub. No.: US 2004/0103446 A1
(43) Pub. Date: May 27, 2004

(54) Audio-video multiplexed data generating apparatus, reproducing apparatus and moving video decoding apparatus

(75) Inventors: Yoriko Yagi, Otokuni-gun (JP); Kazutoshi Funahashi, Takatsuki-shi (JP); Kengo Nishimura, Suita-shi (JP); Yuji Kazama, Kyoto-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co. Ltd., Kadoma-shi (JP)

(21) Appl. No.: 10/700,461

(22) Filed: Nov. 5, 2003

(30) Foreign Application Priority Data
Nov. 22, 2002 (JP) 2002-338673

(51) Int. Cl. H04N 7/16; H04N 7/173; H04N 5/38; H04N 11/00; H04N 7/00

(52) U.S. Cl. 725/146; 348/723; 348/462; 725/90; 725/114; 725/144

(57) ABSTRACT

An audio-video multiplexed data generation apparatus of the present invention multiplexes spare video data encoded at a lower frame rate than that of video data together with audio and video data through a spare-video encoder and a spare-video-data storage. An audio-video multiplexed data reproducing apparatus of the present invention decodes spare video data if video decoding is not completed within a predetermined time and, when it becomes possible to complete video decoding within the predetermined time, ordinarily decodes the video data. Multiplexing the low-frame-rate spare video data together with the ordinary video data allows irregularities in reproduced video to be minimized and synchronization between audio and video data to be restored if real-time reproduction becomes difficult to accomplish.

### FIELD OF THE INVENTION

The present invention relates to an audio-video multiplexed data generating apparatus and a multimedia data reproducing apparatus.

### BACKGROUND OF THE INVENTION

Multimedia data multiplexing technologies that enable recording and reproducing multimedia data such as audio and moving video pictures are essential in digital audio-video devices in these years. There are various standards such as ASF (Advanced Systems Format) and MPEG-4 MP4 (Moving Picture Experts Group phase 4).

Among the multimedia data multiplexing technologies, an audio-video combining technology that multiplexes audio and video data adds playback/display time called the PTS (Presentation Time Stamp) as synchronization information to the multiplexed data it generates. When the multiplexed data is reproduced, the multiplexed data is demultiplexed into the audio and video data and the synchronization information, and then the audio-video data is reproduced/displayed according to the synchronization information, PTS, thus achieving the synchronized audio and video reproduction.

FIG. 19 shows an audio-video multiplexed data generating apparatus according to the prior-art, FIG. 20 shows audio-video multiplexed data according to the prior-art, and FIG. 21 shows an audio-video multiplexed data reproducing apparatus according to the prior art (for example the one disclosed in patent document 1).

The prior-art audio-video multiplexed data generating apparatuses comprises an audio encoder 1901 encoding audio data inputted from a microphone MI, an audio data storage 1904 storing the encoded audio data, a video encoder 1903 encoding video data inputted from a camera CA, a video data storage 1906 storing the encoded video data, a synchronization information generator 1902 generating synchronization information for synchronizing the audio and video data, a synchronization information storage 1905 storing the synchronization information, and an audio-video multiplexer 1907 multiplexing the audio data stored in the audio data storage 1904, video data stored in the video data storage 1906, and the synchronization information stored in the synchronization information storage 1905.

The prior-art audio-video multiplexed data generating apparatus adds the synchronization information (PTS) to each of the encoded audio and video data to generate multiplexed data. FIG. 20 shows the multiplexed data.

Data are multiplexed in different ways: synchronization information may be added as a header to each of audio data and video data, or synchronization information for all items of audio and video data may be stored in a single location, for example.

The prior-art audio-video multiplexed data reproducing apparatus comprises an audio-video demultiplexer 2101 demultiplexing multiplexed data into audio data, video data, and synchronization information, an audio data storage 2102 storing the demultiplexed audio data, a image data storage 2104 storing the demultiplexed video data, a synchronization information storage 2103 storing the demultiplexed synchronization information, an audio decoder 2105 decoding the audio data, a video decoder 2107 decoding the video data, and a synchronization controller 2106 activating the audio decoder 2105 and the video decoder 2107 according to the synchronization information for the audio and video data, as shown in FIG. 21. Signals resulting form decoding by the audio decoder 2105 are reproduced in a speaker SP and signals resulting from decoding by the video decoder 2107 are played on a display DP.

In this way, in the prior-art audio-video multiplexed data reproducing apparatus, the audio decoder 2105 and the video decoder 2107 are operated according to synchronization information obtained by demultiplexing to synchronize and reproduce audio data and video data.

However, it is difficult to reproducing audio and video data in synchronization with each other in real time because the CPU had a limited throughput to implement the whole audio-video multiplexed data reproducing apparatus through software.

Furthermore, if a number of applications are running concurrently, demultiplexing and decoding in those applications cannot be completed in a predetermined period of time because the execution of them transitions from the audio-video multiplexed data reproducing apparatus to another device or another state. Consequently, it becomes difficult to provide synchronized reproduction of audio and video data in real time.

Especially if the audio-video multiplexed data reproducing apparatus is implemented by software, a heavy workload is placed on the video decoder 2107. In some cases, when real-time synchronized reproduction becomes difficult to accomplish, decoding of video data is suspended and the video data is not displayed (skipped) in order to deal with the problem. However, it is impossible to skip only the single frame of video data that cannot be decoded in time because video data basically is a difference picture between the current frame and the previous frame. If that frame were skipped, irregularities would occur in the video data in the next frame and accordingly a number of frames of video data would be skipped until the next reference video data is encountered. As a result, discontinuity of the reproduction of moving picture would become noticeable.

An object of the present invention is to provide an audio-video multiplexed data generating apparatus and reproducing apparatus and an moving video decoding apparatus that can minimize loss of audio-video synchronization, which may occur when decoding of moving pictures is not completed within a predetermined period of time, and irregularities in reproduced moving picture, which may occur when the audio-video multiplexed data is reproduced by software processing.

### DISCLOSURE OF THE INVENTION

In order to solve the problem, an audio-video multiplexed data generating apparatus of the present invention includes a spare-video encoder that encodes inputted video data at a frame rate lower than that in a video encoder to generate spare video data and a spare-video-data storage that stores the spare video data, in addition to a conventional configuration.

An audio-video multiplexed data reproducing apparatus of the present invention includes a spare-video-data storage that demultiplexes spare video data from multiplexed data and stores spare video data and a video data selector that selects video data or spare video data to be decoded, in addition to a conventional configuration.

In the audio-video multiplexed data generating apparatus, video data encoded at a normal frame rate and spare video data encoded at a lower frame rate are multiplexed. In the audio-video multiplexed data reproducing apparatus, if decoding of normal-frame-rate video data is not completed within a predetermined time for some reason, lower-frame-rate spare video data multiplexed as spare video is decoded. The decoding of the spare video data is continued until the video decoder can complete the decoding within the predetermine time. Multiplexing low-frame spare video data beforehand and, if real-time reproduction becomes difficult to accomplish, decoding the spare video data as described above can prevent failure of the system and provide relatively smooth reproduction of moving pictures.

The audio-video multiplexed data generating apparatus of the present invention further includes a spare-audio encoder that has the same audio input as that of the audio encoder and a spare-audio-data storage that stores spare audio data encoded by the spare-audio encoder. The audio-video multiplexed data reproducing apparatus of the present invention further includes a spare-audio-data storage that stores spare audio data demultiplexed by an audio-video demultiplexer and an audio selector that selects the audio data or the spare audio data to be decoded.

The audio-video multiplexed data generating apparatus having this configuration multiplexes audio data encoded with an ordinary encoding scheme and spare audio data encoded with a simple encoding scheme that involves a smaller amount of processing. In the audio-video multiplexed data reproducing apparatus, if it is determines during decoding of normal audio data that the audio decoding cannot be completed in time, the spare audio data that is encoded with the simple encoding scheme that involves a lower amount of processing and multiplexed as spare audio data is decoded. Until the audio decoder is completed within a predetermined time, decoding of the spare audio data is continued. Multiplexing the spare audio data that requires a smaller amount of processing beforehand in this way and, if real-time reproduction becomes difficult to accomplish, decoding the spare audio data can prevent failure of the system. The present invention is especially advantageous in a system in which its video decoder is implemented by hardware and accordingly causes little delay but its audio decoder causes noticeable delays.

A moving video decoding apparatus of the present invention includes a video decoding determination module that determines whether or not decoding of video data is completed within a predetermined time and a video decoder that partially omits image decoding to reduce the amount of processing, according to the determination in the video decoding determination module.

According to this configuration, if the image decoding determination module determines that it is difficult to complete video decoding within a predetermined time, the amount of processing by the video decoder is reduced. Thus, decoding of moving pictures that would otherwise be difficult to reproduce in real time by software can be achieved.

### BRIEF DESCRIPTION OF THE DRAWINGS

FIG. 1 is a block diagram showing a configuration of an audio-video multiplexed data generating apparatus in an audio-video multiplexed data generating/reproducing system according to a first embodiment of the present invention;

FIG. 2 is a block diagram of an audio-video multiplexed data reproducing apparatus according to the first embodiment;

FIG. 3 is a diagram illustrating an example of audio-video multiplexed data according to the first embodiment;

FIG. 4 is a diagram illustrating an example of audio-video multiplexed data according to the first embodiment;

FIG. 5 is a diagram showing an example of reproduction of video data contained in audio-video multiplexed data according to the first embodiment;

FIG. 6 shows exemplary timing for showing video data contained in audio-video multiplexed data according to the first embodiment;

FIG. 7 is a block diagram showing a configuration of an audio-video multiplexed data generating apparatus in an audio-video multiplexed data reproducing system according to a second embodiment of the present invention;

FIG. 8 is a diagram illustrating an example of audio-video multiplexed data according to the second embodiment;

FIG. 9 is a block diagram showing a configuration of an audio-video multiplexed data reproducing apparatus according to the second embodiment;

FIG. 10 is a flowchart of a process performed in a moving video decoding apparatus according to a third embodiment of the present invention;

FIG. 11 is a diagram illustrating an example in which the number of orthogonal transformation macroblocks is orderly reduced according to the third embodiment;

FIG. 12 is a flowchart of a process performed in a moving video decoding apparatus according to a fourth embodiment of the present invention;

FIG. 13 is a diagram illustrating an example in which video decoding is omitted orderly on a macroblock-by-macroblock basis according to the fourth embodiment;

FIG. 14 is a flowchart of a process performed in a moving video decoding apparatus according to a fifth embodiment of the present invention;

FIG. 15 is a diagram illustrating an example in which video decoding is omitted on a macroblock-by-macroblock basis in accordance with motion vectors according to the fifth embodiment;

FIG. 16 is a flowchart of a process performed in a moving video decoding apparatus according to a sixth embodiment of the present invention;

FIG. 17 is a diagram illustrating an example (in which video decoding is completed within a time limit) of execution time in a video decoder, a color converter, and a video display according to the sixth embodiment;

FIG. 18 is a diagram for illustrating an example (in which video decoding is not complete within a time limit) of execution time in the video decoder, color convert, and video display according to the sixth embodiment;

FIG. 19 is a block diagram showing a configuration of an audio-video multiplexed data generating apparatus according to a prior art;

FIG. 20 is a diagram illustrating an example of audio-video multiplexed data according to a prior art;

FIG. 21 is a block diagram showing a configuration of an audio-video multiplexed data reproducing apparatus according to a prior art;

FIG. 22 is a diagram illustrating synchronization information stored in a synchronization information storage 106 in a synchronization information storage of the audio-video multiplexed data generating apparatus according to the first embodiment of the present invention; and

FIG. 23 is a diagram illustrating synchronization information stored in a synchronization information storage 203 of the audio-video multiplexed data reproducing apparatus according to the first embodiment of the present invention.

### DESCRIPTION OF THE EMBODIMENTS

An audio-video multiplexed data generating apparatus and reproducing apparatus and moving video decoding apparatus of the present invention will be described below with reference to the accompanying drawings.

First Embodiment

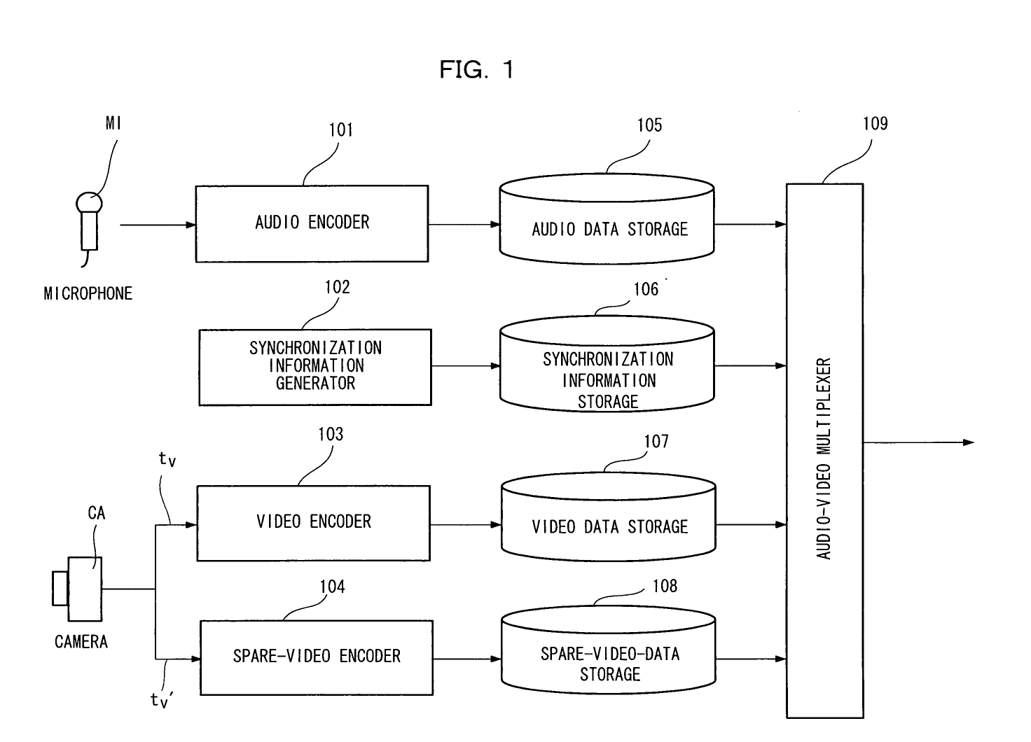

FIGS. 1 to 5 show a first embodiment of the present invention.

FIG. 1 shows an audio-video multiplexed data generating apparatus according to the first embodiment of the present invention.

The audio-video multiplexed data generating apparatus comprises an audio encoder 101 that receives audio data on a frame-by-frame basis as its input and encodes the audio data, an audio data storage 105 that stores audio data encoded by the audio encoder 101, a video encoder 103 that receives video data on a page-by-page basis as its input and encodes the image data at a predetermined frame rate, a video data storage 107 that stores the image data encoded by the video encoder 103, a spare-video encoder 104 that encodes video data at a frame rate different from that in the video decoder 103, a spare-video-data storage 108 that stores spare video data encoded by the spare-video encoder 104, a synchronization information generator 102 that generates synchronization information for audio data, video data, and spare video data encoded by the audio encoder 101, video decoder 103, and spare-video encoder 104, respectively a synchronization information storage 106 that stores synchronization information generated by the synchronization information generator 102, and an audio-video multiplexer 109 that multiplexes audio data stored in the audio data storage 105, video data stored in the video data storage 107, spare video data stored in the spare-video-data storage 108, and synchronization information stored in the synchronization information storage 106.

A process flow in the audio-video multiplexed data generating apparatus according to the first embodiment will be described below.

First, audio data is inputted in the audio encoder 101 at regular time intervals tA. The audio encoder 101 encodes the audio data inputted during time interval tA. It then stores the encoded audio data in the audio data storage 105.

On the other hand, video data in page is inputted into the video decoder 103 at regular time intervals tV. The video decoder 103 decodes the inputted video data in page. Similarly to the audio data, the encoded video data is stored in the video data storage 107.

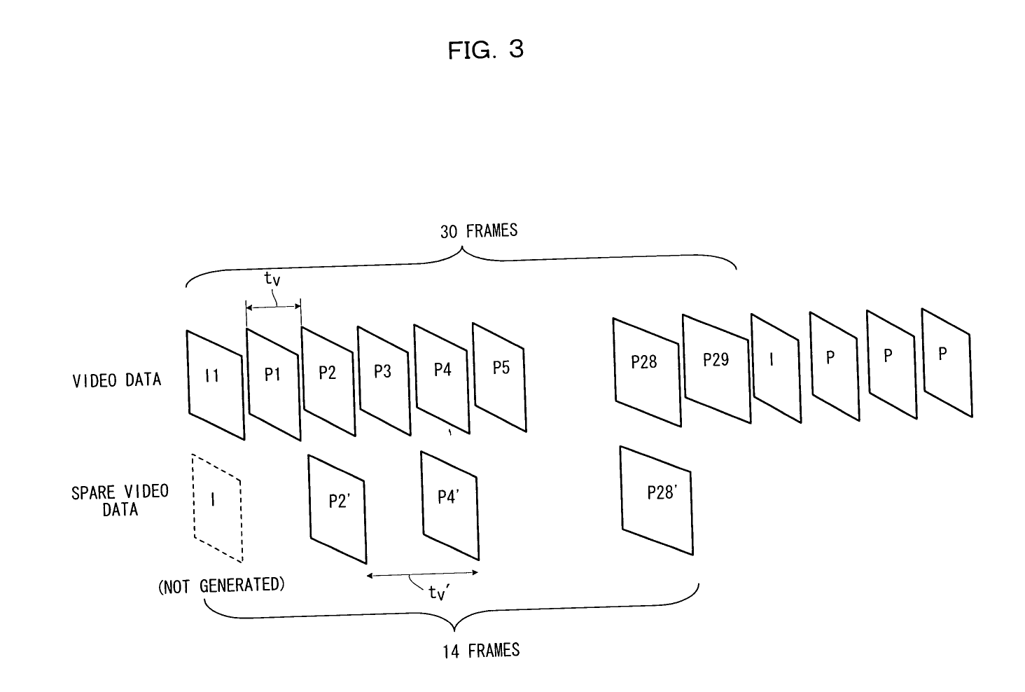

Video data in one page is inputted into the spare-video encoder 104 at encode time intervals tV′ longer than the video data encode time intervals tV. The spare-video encoder 104 encodes the inputted video data in the page. FIG. 3 shows examples of video data and spare video data encoded and outputted by the video encoder 103 and the spare-video encoder 104, respectively.

Shown in FIG. 3 are a result of encoding by the video encoder 103 at 30 fps and a result of encoding by the spare-video encoder 104 at 15 fps. Reference picture frames (indicated by “I” in FIG. 3), which have the same video data, are not encoded by the spare-video encoder 104. On the other hand, spare video data in difference picture frames (indicated by “P” in FIG. 3) is encoded at a frame rate lower than the frame rate for ordinary video data. In FIG. 3, the video data is encoded at 30 fps and spare video data is encoded at a frame rate of 15 fps, the half the frame rate for the video data. Accordingly spare video data in 14 frames, excluding the reference picture frames, are encoded per second. Here, P2′ indicates the spare picture of P2, P4′ indicates the spare picture of P4, and P28′ indicates the spare picture of P28. In addition, P2′ is the difference picture of I1, presents an image that resembles P2, and has the same PTS as that of P2. Similarly, P4′ is the difference picture of P2, presents an image that resembles P4, and has the same PTS as that of P4. P28′ is the difference picture of p26, presents an image similar to P28, and has the same PTS as that of P28.

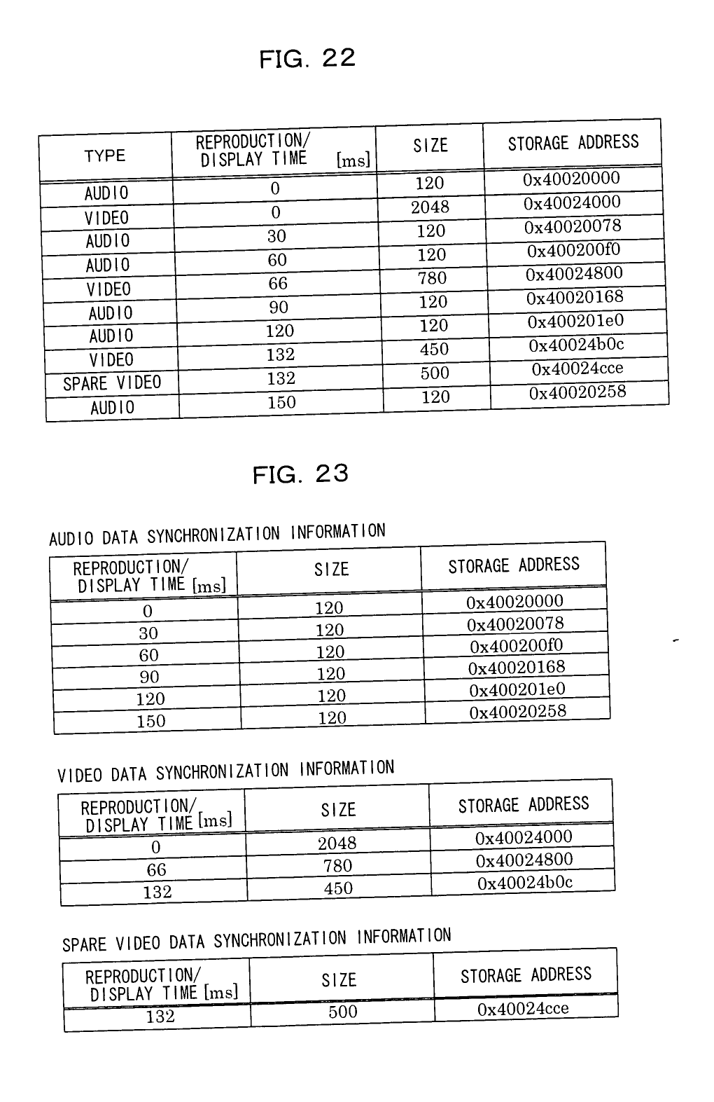

Next, the synchronization information generator 102 generates synchronization information for audio data, video data, and spare video data encoded by the audio encoder 101, video encoder 103, and spare-video encoder 104, respectively. The synchronization information is called the PTS that indicates when to reproduce audio and video multiplexed data. If audio data is encoded at regular intervals tA and video data is encoded at regular intervals tV, then the initial PTS for the audio data is 0, the next PTS is tA, and the subsequent PTSs are multiples of tA, such that 2×tA, 3×tA, and so on. The initial PTS of the video data is 0, the next is tV, and the subsequent PTSs are multiples of tV, such that 2×tV, 3×tV, and so on. The synchronization information is associated with audio data, video data, and spare video data and stored in the synchronization information storage 106. An example of the synchronization information in the synchronization storage 106 is shown in FIG. 22.

The “type” in FIG. 22 indicates one of audio, video, and spare video. The “reproduction/presentation time” indicates in milliseconds when to reproduce or present audio, video, and spare video data. The “size” indicates the size of audio, video, and spare video data. Each of the values indicates the size of data in one frame. The storage addresses indicate the start address of data stored in the audio data storage, video data storage, and spare video data storage. The synchronization information is associated with encoded audio, video, and spare video data in this way and stored in the synchronization information storage 106.

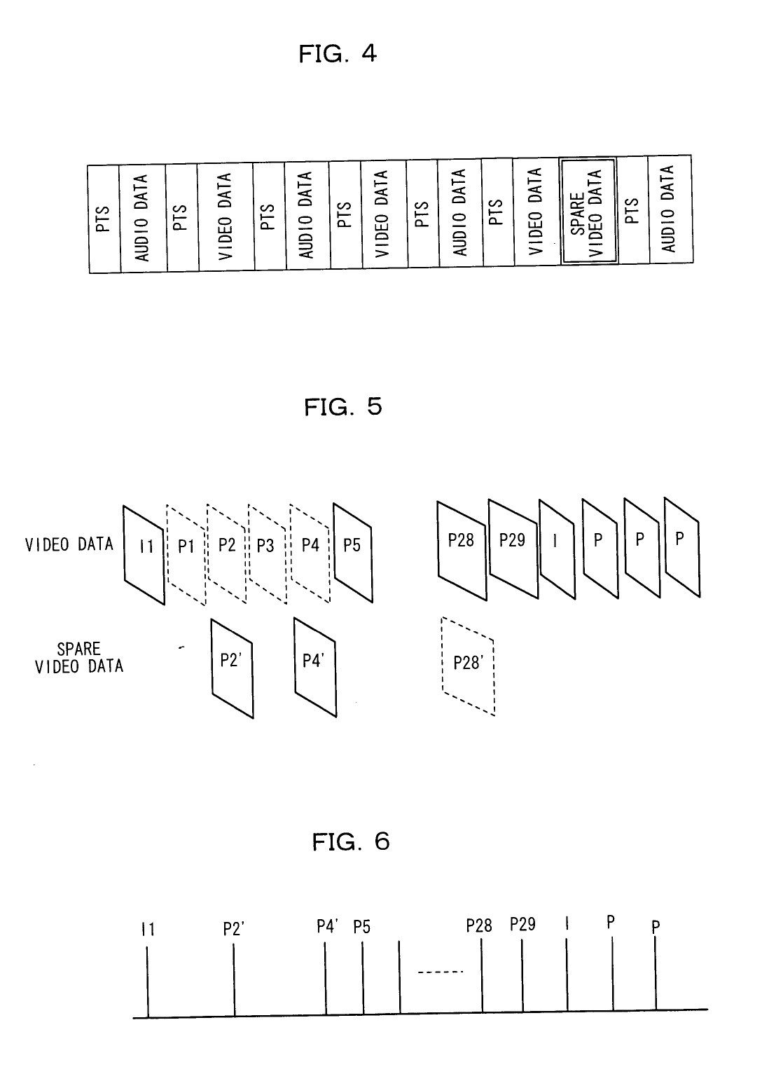

Next, the audio-video multiplexer 109 multiplexes the audio, video, and spare video data according to the synchronization information stored in the synchronization information storage 106. FIG. 4 shows an example of multiplexed data. In FIG. 4, synchronization information, which is a PTS, is prepended to each item of data. Spare video data is stored immediately after video data that has the same PTS as that of the spare video data.

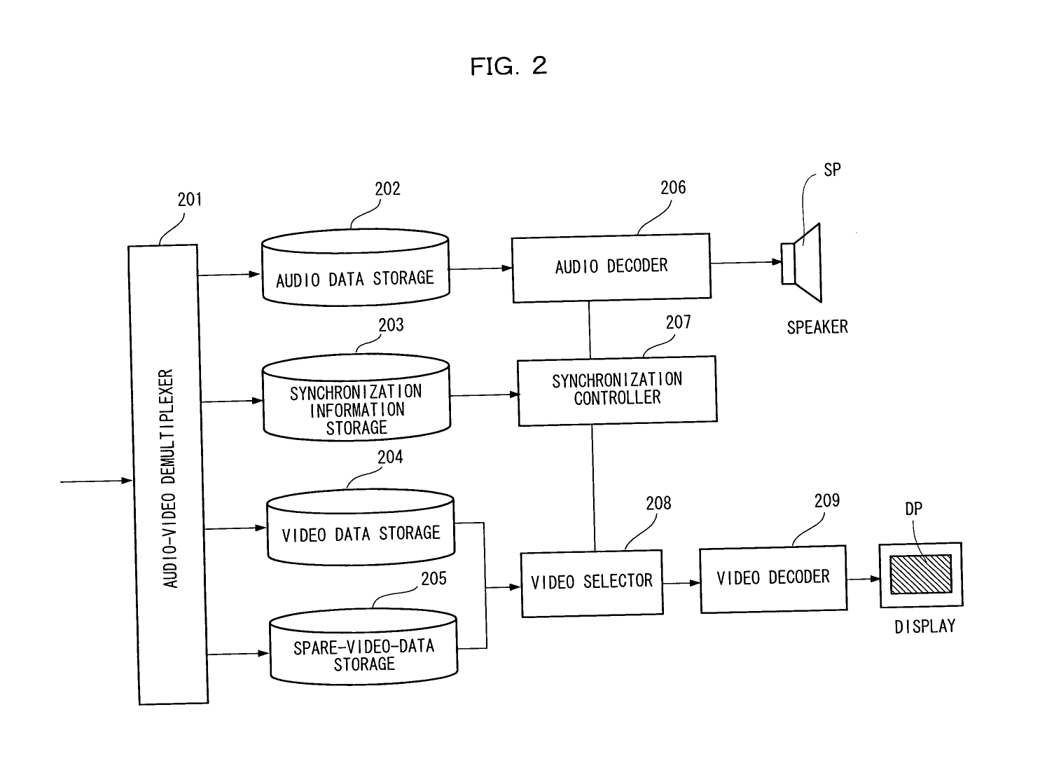

FIG. 2 shows a configuration of an audio-video multiplexed data reproducing apparatus according to the first embodiment of the present invention. The audio-video multiplexed data reproducing apparatus shown in FIG. 2 comprises an audio-video demultiplexer 201 that receives multiplexed data as its input and demultiplexes the data, an audio data storage 202 that stores the audio data demultiplexed by the audio-video demultiplexer 201, a video data storage 204 that stores demultiplexed by the audio-video demultiplexer 201, a spare-video-data storage 205 that stores spare video data demultiplexed by the audio-video demultiplexer 201, a synchronization information storage 203 that stored synchronization information demultiplexed by the audio-video demultiplexer 201, an audio decoder 206 that decodes the audio data stored in the audio data storage 202, a video selector 208 that selects the video data stored in the video data storage 204 or the spare video data stored in the spare-video-data storage 205, a video decoder 209 that decodes video data selected by the video selector 208, and a synchronization controller 207 that controls execution by the audio decoder 206, video selector 208, and video decoder 209 to reproduce the multiplexed data according to the synchronization information stored in the synchronization information storage 203.

A process flow in the audio-video multiplexed data reproducing apparatus according to the present embodiment will be described below.

First, multiplexed data is inputted into the audio-video demultiplexer 201 and demultiplexed into audio data, video data, spare video data, and synchronization information. These pieces of data are stored in the audio data storage 202, video data storage 204, spare video data storage 205, and synchronization information storage 203, accordingly.

The synchronization information stored in the synchronization information storage 203 is PTSs, which is synchronization information associated with the audio data, video data, and spare video data. An example of the synchronization information is shown in FIG. 23.

As shown in FIG. 23, each of the audio, video, and spare video data has synchronization information.

The synchronization controller 207 controls the audio decoder 206 and the video decoder 209 so that the audio and video data can be reproduced/presented in synchronization with each other. Either video data or spare video data, whichever is selected by the video selector 208, is decoded by the video decoder 209.

The video selector 208 basically selects video data stored in the video data storage 204. However, if the video decoder 209 does not complete decoding within a predetermined time, the video selector 208 selects spare video data stored in the spare-video data storage 205 and inputs it in the video decoder 209.

It is assumed here that demultiplexed video data is as shown in FIG. 3, for example, and the demultiplexing of video data 11 is not completed within a predetermined time. Normally, video data P1 must be decoded after video data I1 is decoded. However, because decoding of video data I1 has not been completed in time, the video selector 208 skips P1 and selects spare video data P2, and inputs it in the video decoder 209. Here, P2′ is a difference picture from I1. Accordingly, the omitting the decoding of P1 does not have a harmful influence. Therefore, after the decoding of I1 is completed, decoding of P2′ is started. If the decoding of P2′ also is not completed within the predetermine time, the video selector 208 skips P3 and selects spare video data P4′ and inputs it in the video decoder 209. In this way, if the video decoder 209 cannot complete decoding within a predetermined time, the video selector 208 selects spare video data instead of video data. Then, when it becomes possible for the video decoder 209 to complete decoding within the predetermined time, the video selector 208 selects video data as usual. FIG. 5 shows video data which is presented when spare video data P2′ and P4′ are selected.

In FIG. 5, video data is represented in solid lines. FIG. 6 shows a timing diagram of presentation of the video data shown in FIG. 5. The frame rate of video data I1 and P2′ the decoding of which has not been completed within the predetermined time does not match the frame rate of video data. Consequently, the moving picture in that part is not smoothly reproduced. However, after the video decoder 209 completes decoding within the predetermined time, the original frame rate is recovered and the smoothness of reproduction of the moving picture recovered accordingly. According to the prior-art, when it becomes difficult to reproduce the data in real time as in this example, synchronization between audio and video data is lost because the delay in video decoding remains. Or, when real-time reproduction becomes difficult to accomplish, decoding of every difference picture is omitted until the next reference picture data is encountered, resulting in considerable irregularities in reproduced moving picture.

The difficulty in real-time reproduction cannot be necessarily prevented by a sufficient CPU throughput. When a number of applications are running, suspension of audio-video multiplexing may inhibit real-time reproduction even if the throughput of the CPU is high. The audio-video multiplexed data generating apparatus and reproducing apparatus according to the present invention can also be used as a fail-safe system for an audio-video multiplexed data reproduction apparatus.

In summary, according to the first embodiment, video data is previously multiplexed with lower-frame-rate spare video data in case that real-time reproduction of multiplexed data becomes difficult to accomplish. Thus, irregularities in video reproduction which may occur if the video decoder cannot complete decoding in time can be minimized and moving picture reproduction at the original frame rate can be restored.

Second Embodiment

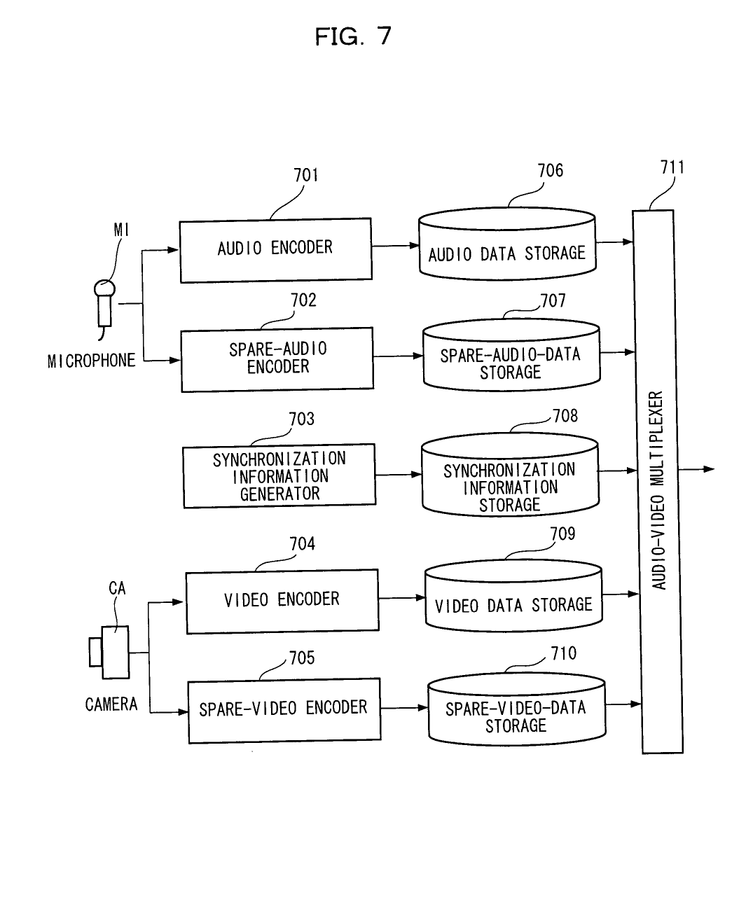

FIGS. 7 to 9 show a second embodiment of the present invention.

According to the second embodiment, further provided in the audio-video multiplexed data generating apparatus of the embodiment are a spare-audio-data decoder having the same audio input as an audio encoder and a spare-audio-data storage for storing spare audio data encoded by the spare-audio encoder are provided in the audio-video multiplexed data generating apparatus of the first embodiment. Moreover, according to the second embodiment, further provided in the audio-video multiplexed data reproducing apparatus of the first embodiment are a spare-audio-data storage for storing spare audio data demultiplexed by an audio-video demultiplexer and an audio selector that selects audio data or spare audio data to be decoded.

FIG. 7 shows an audio-video multiplexed data generating apparatus according to the second embodiment of the present invention, in which reference numbers 701, 703, 704, 705, 706, 708, 709, and 710 indicate the same components as those indicated by reference numbers 101, 102, 103, 104, 105, 106, 107, and 108, respectively, in the first embodiment.

The spare-audio encoder 702 in FIG. 7 encodes spare audio data by using the same audio input as that of an audio encoder 701. The spare-audio encoder 702 performs audio encoding using simple encoding having less processing amount than that of the audio encoder 701. The encoded spare audio data is stored in a spare-audio-data storage 707.

If an audio data frame is skipped during reproduction, audible noise is generated. Therefore spare audio data is provided for all pieces of audio data. For example, AMR (adaptive multi-rate) encoding may be used for the audio encoder and G.726 encoding, which involves a smaller amount of processing than that of AMR, maybe used for the spare-audio encoder. AMR data may be stored in the audio data storage and G.726 data may be stored in the spare-audio-data storage.

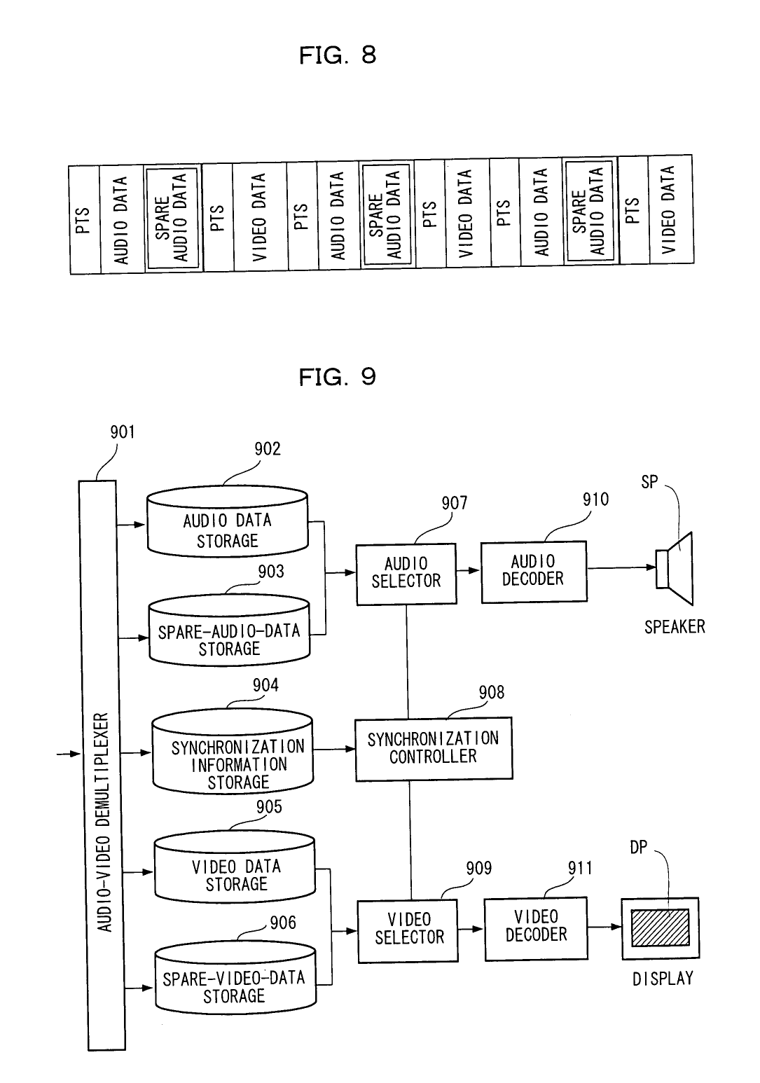

An audio-video multiplexer 711 adds synchronization information to audio, video, spare audio, and spare video data to generate multiplexed data. FIG. 8 shows an example of multiplexed data. In FIG. 8, a PTS is prepended to each piece of data and spare audio data follows the audio data that has the same PTS as that of the spare audio data.

FIG. 9 shows an audio-video multiplexed data reproducing apparatus according to the second embodiment of the present invention. Reference numbers 902, 904, 905, 906, 909, 910, and 911 indicate the same components as those indicated by reference numbers 202, 203, 204, 205, 208, 206, and 209, respectively, in the first embodiment.

Multiplexed data is inputted into an audio-video demultiplexer 901, where it is demultiplexed into audio data, video data, spare audio data, spare image data, and synchronization information.

An audio selector 907 basically selects audio data stored in an audio data storage 902 under the control of a synchronization controller 908. However, if it is determined that an audio decoder 910 cannot complete decoding within a predetermined time, the audio selector 907 selects spare audio data in a spare-audio-data storage 903 and inputs it into the audio decoder 910. Afterward, when it is determined that the audio decoder 910 can complete decoding within the predetermined time, the audio selector 907 selects audio data in the audio data storage 902. Using the example described above, the audio selector 907 normally selects AMR data stored in the audio data storage. However, if it is determined that decoding cannot be completed in time, it selects G.726 data stored in the spare-audio-data storage 903 for audio decoding.

Thus, if real-time reproduction becomes difficult to accomplish, spare audio data, which is encoded with a simple encoding scheme that involves a smaller amount of processing than audio data and which therefore may require a smaller amount of audio decoding, is selected and audio decoding is performed. Consequently, synchronization between audio and video data can be maintained. This system is effective especially in a system in which video decoding is provided by hardware and audio decoding is provided by software.

In summary, according to the second embodiment, spare audio data encoded with a simple encoding scheme that involve a smaller amount of processing is previously multiplexed with audio data in case that real-time reproduction of multiplexed data becomes difficult to accomplish. Thus, irregularities in audio reproduction, which may occur if the audio decoder 910 cannot complete decoding in time, can be minimized.

Third Embodiment

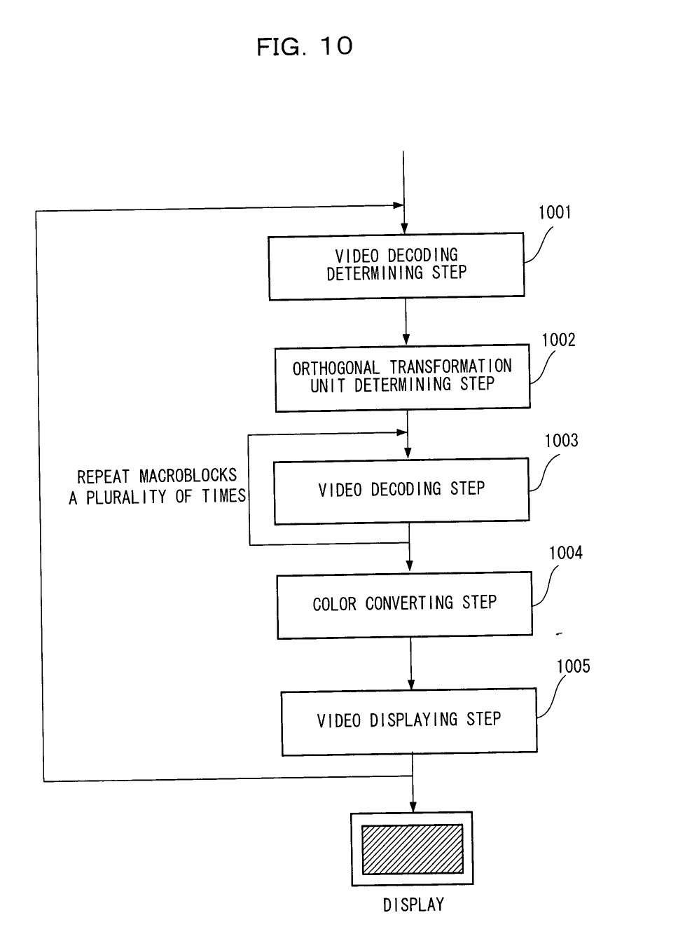

FIG. 10 shows a flowchart of a process performed in a moving video decoding apparatus implemented by a computer according to a third embodiment of the present invention.

The moving video decoding apparatus shown in FIG. 10 has a video decoding determining module that performs the video decoding determining step 1001 of determining whether or not decoding of inputted video data completes within a predetermined time, an orthogonal-transformation-unit-determining module that performs the orthogonal transformation unit determining step 1002 of determining the size of unit of orthogonal transformation performed at a video decoding step 1003, a video decoder that performs the video decoding step 1003 of decoding the inputted video data on a macroblock-by-macroblock basis, a color converter performs a color converting step 1004 of that applying color conversion to the encoded video data outputted in the video decoding step 1003, and a video display that performs video displaying step 1005 of displaying the result of color conversion outputted in the color converting step 1004.

The moving video decoding apparatus of the present invention can be used as the video decoder 209 of the first embodiment or the video decoder 911 of the second embodiment.

A process flow in the video decoding apparatus will be described below.

First, video data is inputted in the video decoding determining step 1001 on a frame-by-frame basis, where it is determined whether or not decoding of the input data can be completed within a predetermine time. For example an internal clock is used to measure the difference between time at which the video data has been inputted and the time at which the decoding of the video data must be completed. The difference time is the time to be assigned to the decoding. If the time is smaller than a predetermined value, it is determined that the video decoding cannot be completed within that time.

Then, in the orthogonal transformation determining step 1002, the size of unit for orthogonal transformation is determined according to the determination made at the video decoding determination step 1001. It is assumed in this example that IDCT (Inverse Discrete Cosine Transform), for example, is used. If it is determined at the video decoding determining step 1001 that the video decoding is completed within the predetermined time, the size of the IDCT processing unit is set to 8×8. On the other hand, if it is determined at the video decoding determining step 1001 that the video decoding is difficult to complete within the predetermine time, then the size of the IDCT processing unit is set to 4×4.

Next, in the video decoding step 1003, the inputted video data is decoded on a macroblock-by-macroblock basis. In the video decoding step 1003, the size of unit of IDCT processing determined at the orthogonal transformation unit determining step 1002 is used for the decoding. Accordingly, the amount of decoding is reduced because the size of unit of IDCT processing has been set to a smaller value if it is determined that the video decoding cannot be completed within the predetermined time. The reduction of the IDCT processing time may be performed all macroblocks. Alternatively, the reduction in the size of unit of IDCT processing may be performed only on certain macroblocks in an orderly manner.

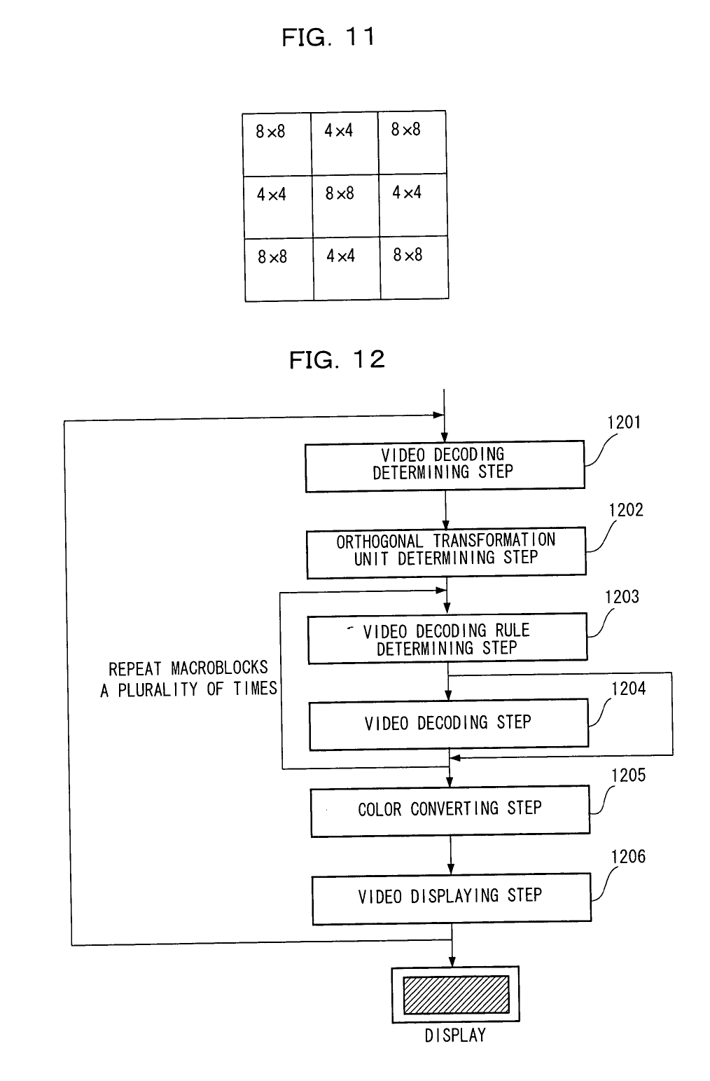

FIG. 11 shows an example in which reduction in size of the IDCT processing unit is performed checkerwise. Arranging checkerwise the macroblocks in which the size of unit of IDCT processing is reduced to 4×4 as shown in FIG. 11 can reduce the amount of processing in the entire video decoding apparatus.

Finally, YUV (Y-signal U-signal V-signal) data, which is the result of the video decoding outputted from the video decoding step 1003, is converted into RGB (Red Green Blue) data in the color converting step 1004 and the RGB data is displayed on the display in the video displaying step 1005.

The video decoding determining step 1001, the IDCT processing unit determining step 1002, the video decoding step 1003, the color converting step 1004, and the video displaying step 1005 are repeated for each frame of video data.

According to the third embodiment, it is determined at the video decoding determining step 1001 whether or not video decoding can be completed within the predetermine time, the size of unit of orthogonal transformation is determined in the orthogonal transformation unit determining step 1002 according to the determination, and the size of unit of orthogonal transformation determined at the orthogonal transformation unit determining step 1002 is used in the video decoding step 1003. Thus, the amount of processing in the video decoder can be reduced, and the moving picture can be reproduced with minimum irregularities if the moving picture becomes difficult to reproduce in real time.

Fourth Embodiment

In a fourth embodiment of the present invention, a video decoding rule determining step 1203 is provided between the orthogonal transformation determining step 1002 and the video decoding step 1003 of the third embodiment.

FIG. 12 shows a flowchart of a process performed in a moving video decoding apparatus according to the fourth embodiment of the present invention. The process flow in the fourth embodiment will be described below.

In the video decoding determining step 1201 as a video-decoding-determining module in FIG. 12, it is determined whether video decoding is completed in a predetermined time.

In the orthogonal transformation unit determining step 1202 as an orthogonal-transformation-unit-determining module, the size of unit of orthogonal transformation is determined according to the determination made at the video decoding determining step 1201.

Then, at the video decoding rule determining step 1203 as a video-decoding-rule-determining module, a rule for omitting decoding at the video decoding step 1204 is determined. If it is determined in the video decoding unit determining step 1202 that the video decoding cannot be completed within a predetermined time, then the decoding of that video data, which would be performed in the video decoding step 1204, is omitted according to the rule determined at the video decoding rule determining step 1203.

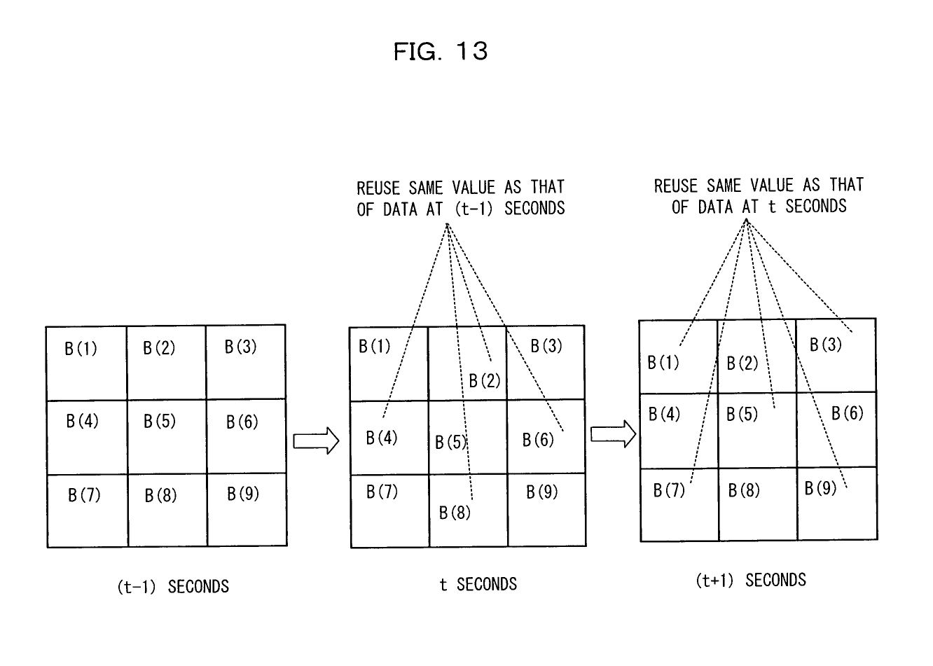

FIG. 13 shows an example in which video decoding is omitted according to a rule.

In FIG. 13, macroblocks at time (t−1) seconds to (t+1) seconds are shown. For example, if macroblocks are checkerwise omitted from video decoding, only macroblocks B(1), B(3), B(5), B(7), and B(9) are subjected to video decoding at t seconds and values used at the previous time, (t−1) seconds, are reused for macroblocks B(2), B(4), B(6) and B(8). Likewise, at (t+1) second, video decoding is applied to only macroblocks B(2), B(4), B(6), and B(8) and values used at the previous time, t seconds, are reused for macroblocks B(1), B(3), B(5), B(7), and B(9). Omitting video decoding in an orderly manner in this way can reduce the amount of processing in the entire video decoder.

The method for reducing the amount of video decoding can be used with the method for reducing the size orthogonal transformation unit described with respect to the third embodiment.

In summary, according to the fourth embodiment, it is determined in the video decoding determining step 1201 whether or not video decoding can be completed within a predetermined time, and according to the determination result, the size of unit of orthogonal transformation is determined in the orthogonal transformation unit determining step 1202. And, by orderly omitting the performance of the video decoding step 1204 in the video decoding rule determining step 1203, the amount of processing in the entire video decoding step 1204 can be reduced, and even when the moving picture cannot be reproduced in real time, irregularities which could occur in reproduced moving picture can be minimized during reproduction.

Fifth Embodiment

According to a fifth embodiment of the present, a motion vector determining step 1403 is provided between the orthogonal transformation unit determining step 1002 and the video decoding step 1003 of the third embodiment.

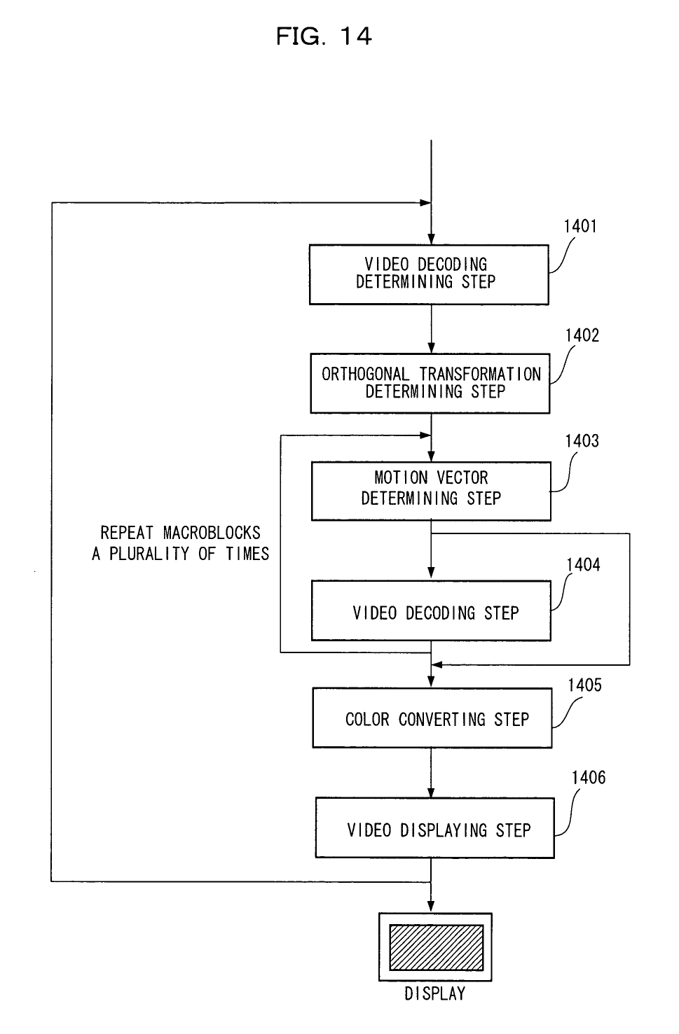

FIG. 14 shows a flowchart of a process in a moving video decoding apparatus according to the fifth embodiment of the present invention. The process flow of the fifth embodiment will be described below.

In the video decoding determining step 1401 as a video-decoding-determining module, it is determined whether or not video decoding can be completed within a predetermined time.

In the orthogonal transformation unit determining step 1402 as an orthogonal-transformation-unit-determining module, the size of unit of orthogonal transformation performed in the video decoding step 1404 as a video decoder is determined according to the determination made in the video decoding determining step 1401.

Then, in the motion vector determining step 1403 as a motion-vector-determining module, the value of motion vector for each macroblock is determined. If it is determined in the video decoding determining step 1401 that the video decoding of video data cannot be completed within the predetermined time, macroblocks in that video data that are determined to have a small motion vector and therefore have little movement from the previous time in the motion vector determining step 1403 and omitted from decoding in the video decoding step 1404.

On the other hand, macroblocks that is determined in the motion vector determining step 1403 to have large motion vectors and therefore have large movement from the previous time are subjected to the decoding in the video decoding step 1404.

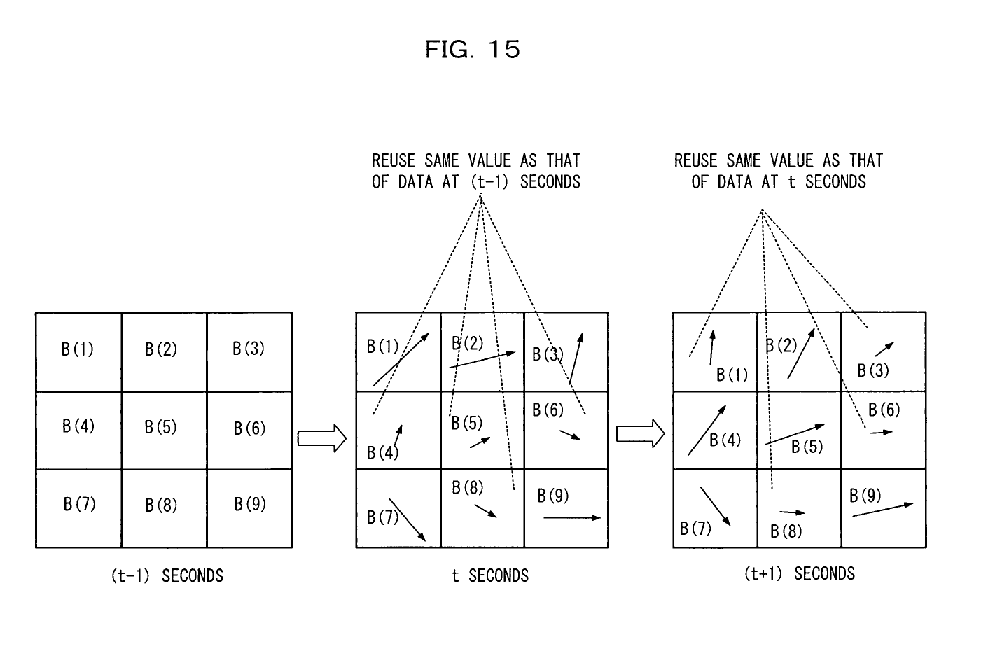

FIG. 15 shows an example in which some macroblocks are omitted from video decoding.

Macroblock at (t−1) seconds to (t+1) seconds and motion vectors are shown in FIG. 15. If it is determined that the vectors of macroblocks B(1), B(2), B(3), B(7), and B(9) at t seconds are greater than a threshold and the vectors of macroblocks B(4), B(5), B(6), and B(8) are less than the threshold in the motion vector determining step 1403, only macroblocks B(1), B(2), B(3), B(7), and B(9) are subject to the video decoding step 1404 and values at the previous time, (t−1) seconds, are reused for macroblocks B(4), B(5), B(6), and B(8). Likewise, if it is determined in the motion vector determining step 1403 that the motion vectors of macroblocks B(2), B(4), B(5), B(7), and B(9) at (t+1) seconds, are greater than the threshold and the macro vectors of macroblocks B(1), B(3), B(6), and B(8) are less than the threshold, the video decoding step 1004 is performed only on macroblocks B(2), B(4) B(5), B(7), and B(9) and values at the previous time, (t) seconds, are used for macroblocks B(1), B(3), B(6), and B(8).

In this way, rather than performing video decoding on all macroblocks, macroblocks that are determined to have small motion vectors in the motion vector determining step 1403 are omitted from the video decoding and data used at the previous time are reused for them. Thus, the amount of processing in the entire video decoder can be reduced.

Step 1405 is the same as step 1205 of the fourth embodiment. Step 1406 is the same as step 1206 of the fourth embodiment.

This method for reducing the amount of video decoding can be used with the method for reducing the size of unit of orthogonal transformation described with respect to the third embodiment.

In summary, according to the fifth embodiment, data used at the previous time are reused for macroblocks that is determined to have moved little on the basis of the motion vectors of the macroblocks in the motion vector determining step 1403 and video decoding is performed only on the macroblocks that are determined to have moved largely. Thus, the amount of processing in the entire video decoding step 1404 can be reduced and irregularities in the reproduced moving picture can be minimized.

Sixth Embodiment

In a sixth embodiment of the present invention, a color conversion determining step 1603 are provided between the video decoding step and the color converting step.

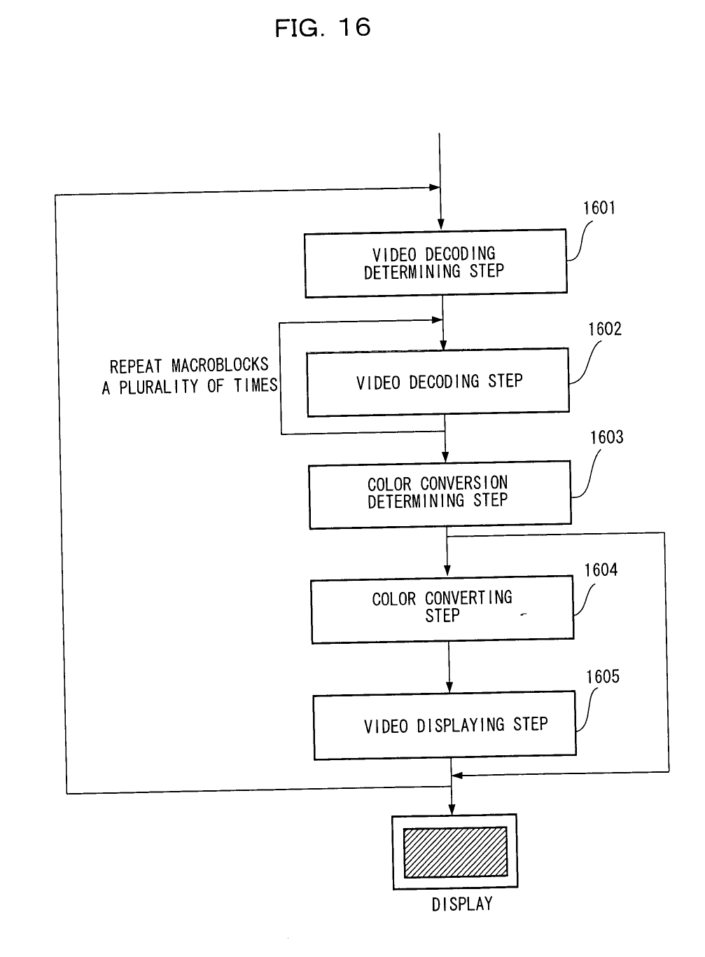

FIG. 16 shows a flowchart of a process in a moving video decoding apparatus according to the sixth embodiment of the present invention. The process flow of the sixth embodiment will be described below.

At the color conversion determining step 1603 as a color conversion determining module in FIG. 16, it is determined whether the color converting step 1604 as a color converting module and the video display step 1605 as a video display are to be performed or omitted.

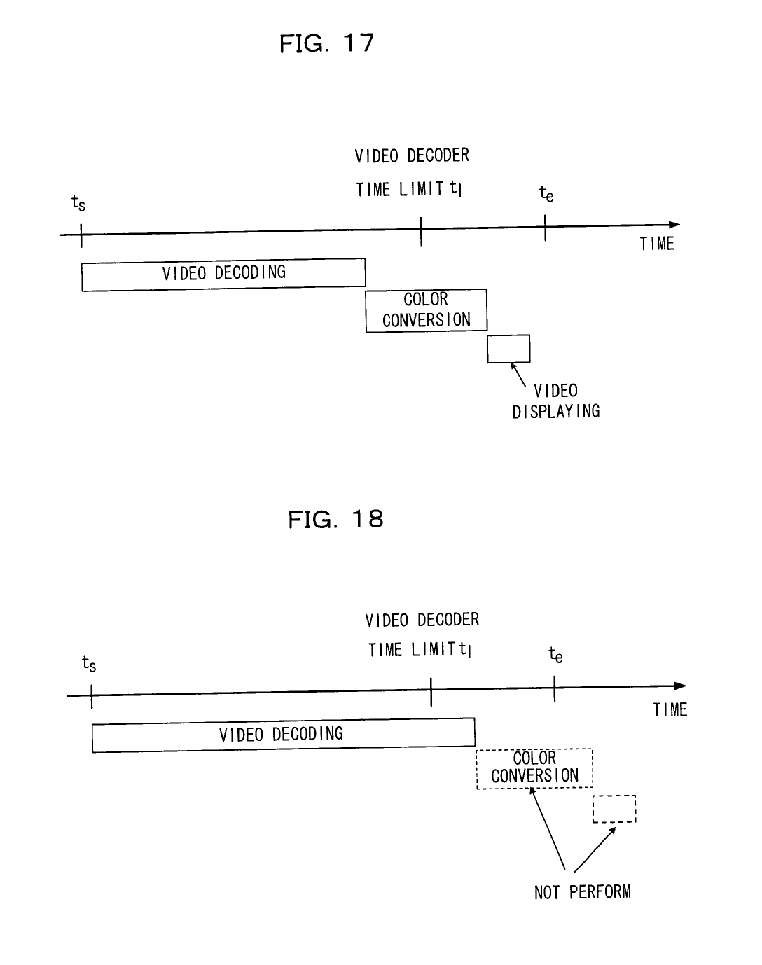

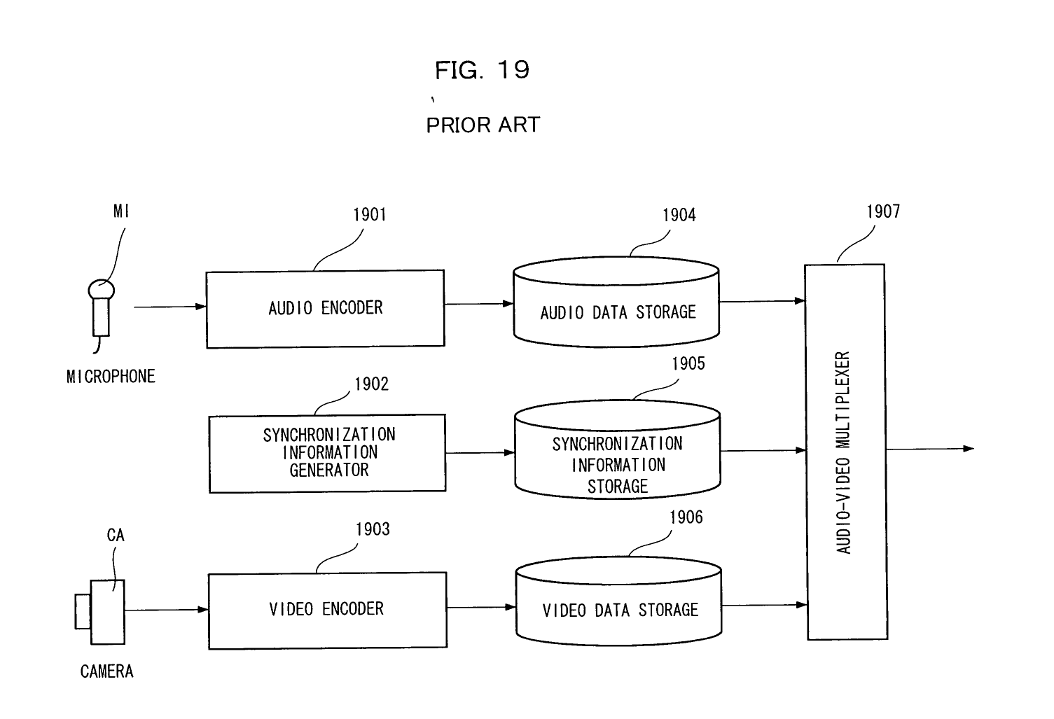

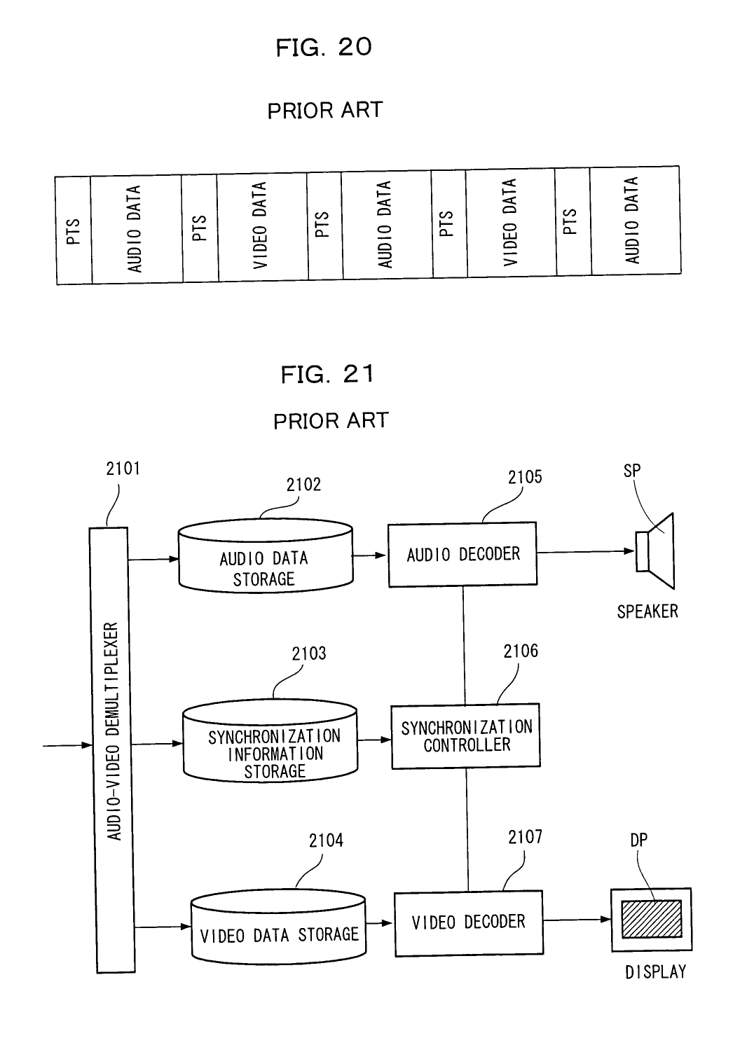

The determination at the color conversion determining step 1603 may be the exclusion of video data that are determined as being a reference picture data at the video decoding determining step 1601 from the color converting step 1604 and the video displaying step 1605. Furthermore, even if the video data is difference picture data, the amount of processing in the video decoding step 1602 as the video decoder can be large. Therefore the color converting step 1604 and the video displaying step 1605 may be omitted depending on the time required for the video decoding step 1602. FIG. 17 shows an example of execution times of the video decoding step 1602, color converting step 1604, and video displaying step 1605.

The sequence of the video decoding step 1602, color converting step 1604, and video display step 1605 must start at time ts and end by time te. The time required for the video decoding step 1602 varies depending on video data, whereas the time required for the video display step 1650 is independent of video data but required substantially the same execution time. Therefore, a video decoding time limit t1 is set as the time limit for the video decoding step 1602. As shown in FIG. 17, if the video decoding step 1602 ends by the time limit t1, the color converting step 1604 and the video displaying step 1605 are performed.

On the other hand, if the time limit t1 is exceeded at the time the video decoding step 1602 is completed as shown in FIG. 18, execution of the color converting step 1604 and the video displaying step 1605 could not be completed by time te. Therefore, the color converting step 1604 and video displaying step 1605 are omitted and consequently the video data is not displayed.

Omitting the video color converting step 1604 and the video displaying step 1605 depending on the time required for execution of the video decoding step 1602 in this way causes a transitory discontinuity in the video data. Nevertheless, this can prevent a delay in the video decoding step 1602 from remaining and, as a result, the next image data can be displayed at predetermined time.

Thus, according to the sixth embodiment, it is determined in the color conversion determining step 1603 whether or not the color conversion and video display should be performed, thereby allowing reproduction of moving picture with minimum irregularities in the picture if real-time reproduction of moving picture becomes difficult to accomplish.

This arrangement of providing the color conversion determining step 1603 between the video decoding step and the color converting step can be applied to any of the third to fifth embodiments.

In summary, according to the present invention, before audio-video multiplexed data is reproduced by using software, spare video data is multiplexed together with video data, thereby minimizing loss of audio-video synchronization and irregularities in reproduced moving picture that occurs when decoding of the moving picture is not completed within the predetermined time. Furthermore, it is determined whether or not video decoding is completed within a predetermined time and the amount of processing in the video decoder is reduced depending on the determination. Thus, moving picture can be reproduced in real time.

What is claimed is:

1. An audio-video multiplexed data generating apparatus that multiplexes audio data and video data together, comprising:
an audio encoder for encoding inputted audio data;
an audio data storage for storing the audio data encoded by said audio encoder;
a video encoder for encoding inputted video data;
a video data storage for storing the video data encoded by the video encoder;
a spare-video encoder for encoding video data at a frame rate different from the frame rate of said video encoder;
a spare-video-data storage for storing the video data encoded by said spare-video encoder;
a synchronization information generator for generating synchronization information for synchronizing the audio data and the video data when multiplexed data is reproduced;
a synchronization information storage for storing the synchronization information generated by said synchronization information generator; and
an audio-video multiplexer for multiplexing the audio data stored in said audio data storage, the video data stored in said video data storage, the spare video data stored in said spare-video-data storage, and the synchronization information generated by said synchronization information generator.

2. The audio-video multiplexed data generating apparatus according to claim 1, wherein said spare-video encoder encodes the video data at a frame rate lower than the frame rate of said video encoder.

3. The audio-video multiplexed data generating apparatus according to claim 1, wherein said spare-video encoder does not encode reference picture data but encodes difference picture data.

4. The audio-video multiplexed data generating apparatus according to claim 1, wherein said audio-video multiplexer successively multiplexes said spare video data supplementing decoding of the video data, in sequence after the video data to be supplemented by the decoding.

5. The audio-video multiplexed data generating apparatus according to claim 1, further comprising:
a spare-audio encoder having the same audio input as said audio encoder; and
a spare-audio-data storage for storing spare audio data encoded by said spare-audio encoder;
wherein said spare-audio encoder generates the spare audio data with a simple encoding scheme that requires a smaller amount of processing than said audio encoder.

6. An audio-video multiplexed data reproducing apparatus that demultiplexes multiplexed audio-video data, comprising:
an audio-video demultiplexer for demultiplexing inputted multiplexed data into audio data, video data, spare video data, and synchronization data;
an audio data storage for storing the audio data demultiplexed by said audio-video demultiplexer;
a video data storage for storing video data demultiplexed by said audio-video demultiplexer;
a spare-video-data storage for storing the spare video data demultiplexed by said audio-video demultiplexer;
a synchronization information storage for storing the synchronization information demultiplexed by said audio-video demultiplexer;
an audio decoder for decoding said audio data;
a video selector for selecting either said video data or said spare-video-data to be decoded;
a video decoder for decoding the video data selected by said video selector; and
a synchronization controller for controlling said audio decoder, said video selector, and said video decoder according to said synchronization information to reproduce the multiplexed data.

7. The audio-video multiplexed data reproducing apparatus according to claim 6, wherein said video selector selects the video data from the video data storage and inputs said video data into the video decoder for performing the video decoder if decoding of the previous video data has been completed when a request for the video decoding is issued from said synchronization controller.

8. The audio-video multiplexed data reproducing apparatus according to claim 6, wherein said video selector selects the spare-video-data from said spare video data storage and inputs said spare video data into said video decoder for executing said video decoder if decoding of the previous video data has not been completed when a request for the video decoding is issued from said synchronization controller.

9. The audio-video multiplexed data reproducing apparatus according to claim 6, further comprising a spare-audio-data storage for storing spare audio data demultiplexed by said audio-video demultiplexer; and
an audio selector for selecting either said audio data or said spare audio data to be decoded;
wherein, if it is determined that decoding of the audio data requested by said synchronization controller is not completed in time, said audio selector selects the spare audio data from said spare-audio-data storage and inputs said spare-audio-data into said audio decoder for audio decoding.

10. A moving video decoding apparatus that decodes moving video data, comprising:
a video-decoding-determining module for determining whether or not video decoding is completed within a predetermined time;
a video decoder for decoding inputted video data on a macroblock-by-macroblock basis;
a color converter for performing color conversion of the decoded data outputted from said video decoder; and
a video display for displaying the color-converted data outputted from said color converter;
wherein said video decoder omits video decoding according to a predetermined rule to reduce the amount of processing depending on the determination made in said video-decoding-determining module.

11. The moving video decoding apparatus according to claim 10, further comprising:
an orthogonal-transformation-unit-determining module after said video-decoding-determining module but before said video decoder, wherein if it is determined in said video-decoding-determining module that it is difficult for the video decoding to be completed within the predetermined time, said orthogonal-transformation-unit-determining module sets the size of unit of orthogonal transformation to a value smaller than a regular value to reduce the amount of processing in said video decoder.

12. The moving video decoding apparatus according to claim 10, further comprising a video-decoding-rule-determining module after said video-decoding-determining module but before said video decoder, wherein if it is determined in said video-decoding-determining module that it is difficult for the video decoding to be completed within the predetermined time, decoding of macroblocks is omitted according to a rule determined by said video-decoding-rule-determining module and the same values that are used in the previous frame are used for said macroblocks the decoding of which is omitted.

13. The moving video decoding apparatus according to claim 10, further comprising a motion-vector-determining module after said video-decoding-determining module but before said video decoder, wherein if it is determined in said video-decoding-determining module that it is difficult for the video decoding to be completed within the predetermine time, macroblocks that are determined to have a small motion vector by said motion-vector-determining module are omitted from the decoding, macroblocks that are determined to have a large motion are subjected to the decoding, and the same values that are used in the previous frame are used for the macroblocks omitted from the decoding.

14. The moving video decoding apparatus according to claim 10, further comprising a color conversion determining module after said video decoder but before said color converter, wherein video data that is determined in said color conversion determining module to be difficult to reproduce in real time is omitted from processing in a color converter and processing in a video display to reduce the amount of processing.

15. The audio-video multiplexed data reproducing apparatus that reproduces multiplexed data according to any of claims 6 to 9, wherein demultiplexed video data is decoded by using the video decoding apparatus according to any of claims 10 to 14.

16. An audio-video multiplexed data generating and reproducing system that encodes audio data and video data, multiplexes the audio and video data together to generate audio-video multiplexed data, and reproduces the audio-video multiplexed data, wherein,
the step of generating audio-video multiplexed data comprises:
encoding inputted video data in a video encoder, and generating spare video data in a spare-video encoder by encoding the video data at a frame rate different from the frame rate of said video encoder;
generating synchronization information for synchronizing the audio data and video data during reproduction of the multiplexed data; and
multiplexing an encoded signal of the audio data, a signal encoded by the video encoder, said synchronization information, and said spare video data together, and
the step of reproducing audio-video multiplexed data comprises the steps of:
demultiplexing the multiplexed data generated in said audio-video multiplexed data generating step into the audio data, video data, synchronization information, and spare video data;
controlling an audio decoder that decodes said demultiplexed audio data and a video decoder that decodes said demultiplexed video data to output reproduced audio and reproduced video in synchronization with each other according to said synchronization information; and
if decoding by said video decoder is not complete in time, decoding by said video decoder the spare video data instead of said demultiplexed video data; and when the decoding by said video decoder is completed within a predetermined time, decoding said demultiplexed video data instead of said spare data by said video decoder to restore the original frame rate of moving video reproduction.
